(19) United States
(12) Patent Application Publication
(10) Pub. No.: US 2011/0000865 A1
(43) Pub. Date: Jan. 6, 2011

(54) CRANE IMPROVEMENTS

(75) Inventors: Thomas E. Jung, Welch, MN (US); Christopher C. Levang, Dayton, MN (US); Mary E. Barker, New Richmond, WI (US); Thomas E. Marrinan, Minneapolis, MN (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: PaR Systems, Inc., Shoreview, MN (US)

(21) Appl. No.: 12/831,246

(22) Filed: Jul. 6, 2010

Related U.S. Application Data
(60) Provisional application No. 61/223,305, filed on Jul. 6, 2009.

(51) Int. Cl. B66C 19/00; B66D 1/14; B66D 1/28

(52) U.S. Cl. 212/73; 254/365

(57) ABSTRACT

Aspects of the present invention relate to crane systems and/or hoists. One aspect includes in combination with a pair of runways in a crane system, a pair of hoist assemblies moveable on the runways, a pair of transfer rails selectively disposable transversely to the runways, the transfer rails including racks for at least a portion of one or both of the hoist assemblies to travel on, a spreader assembly locatable between the hoist assemblies and engaging the runways and/or the hoist assemblies to push the runways or hoist assemblies apart during insertion of the transfer rails between the runways.

### CROSS-REFERENCE TO RELATED APPLICATION

The present application claims the benefit of U.S. Provisional Patent Application Ser. No. 61/223,305, filed Jul. 6, 2009 and entitled “CRANE IMPROVEMENTS,” which is hereby incorporated by reference in its entirety.

### BACKGROUND

The discussion below is merely provided for general background information and is not intended to be used as an aid in determining the scope of the claimed subject matter.

Aspects of the present invention relate to crane and/or hoist systems. Cranes may employ more than one hoist assembly in order to effectively lift and transport loads. In many applications, the hoist assemblies travel upon runways or rails. If for example two hoists are used, hoist assemblies may travel in parallel on parallel runways with the load carried between the runways. However, there may also be a need to also allow the hoist assemblies to transfer to and move on parallel runways that are othogonal to the aforesaid runways. Improvments are continually needed in such crane systems.

In some cases, the hoists may be used in harsh operating environments such as but not limited to onboard a ship. In addition to the wet and corrosive environment, particularly, when the ship is operated in salt water, lowering and raising loads between the ship and the water when significant waves are present can be very difficult.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

Aspects of the present invention relate to improvements for a crane and/or hoist system. A first aspect comprises in combination with a pair of runways in a crane system and a pair of hoist assemblies moveable on the runways and a pair of transfer rails selectively disposable transversely to the runways, the transfer rails including racks for at least a portion of one or both of the hoist assemblies to travel on, a spreader assembly locatable between the hoist assemblies and engaging the runways and/or the hoist assemblies to push the runways or hoist assemblies apart during insertion of the transfer rails between the runways.

The spreader assembly can comprise a first portion engaging one of the runways and/or the hoist assemblies and a second portion engaging another of the runways and/or the hoist assemblies. At least one of the first and second portions can comprise a pivotable link, and in one embodiment each of the first and second portions comprises a pivotable link. The pivotable link(s) can lock in an over-center position in order to push the runways and/or the hoist assemblies apart. Obtaining the over-center position provides a high mechanical advantage.

If desired, the forces applied between the runways and/or hoist assemblies can be spaced apart so as to orient the runways and/or hoist assemblies parallel to each other.

In one embodiment, assembly engages the hoist assemblies and travels with the hoist assemblies for movement of at least one of the hoist assemblies on the transfer rails. The spreader assembly can engage the hoist assemblies with complementary surfaces so as to pull a hoist assembly.

A position sensor can provide a signal indicative of a position of each end of each transfer rail. Various types of actuators and configurations thereof can be used to apply forces to push the hoist assemblies and/or the runways apart. In one embodiment, a plurality of actuators is provided. Each actuator is configured to lower and lift an end of a transfer rail, where the actuators are configured to operate the spreader assembly to push the hoist assemblies and/or the runways apart.

As another aspect a spreader assembly having one or more features described above or otherwise herein described and/or illustrated is also claimed.

In a crane system having a pair of runways in a crane system, a pair of hoist assemblies moveable on the runways and a pair of transfer rails selectively disposable transversely to the runways, the transfer rails including racks for at least a portion of one or both of the hoist assemblies to travel on, a method of inserting the transfer rails between the hoist assemblies and engaging the runways and/or the hoist assemblies by pushing the runways or hoist assemblies apart as described above or otherwise herein described and/or illustrated is also claimed.

As another aspect a crane system includes a pair of runways, a pair of hoist assemblies moveable on the runways, a second pair of rails orthogonal to the pair of runways, a pair of transfer rails, an actuator assembly for lowering the transfer rails so as to align the transfer rails with ends of the second pair of rails, and a locking assembly to lock the transfer rails in position aligned with the end of the second pair of rails. In one embodiment, the locking assembly comprises a pin an aperture connection, while in yet another embodiment, the locking assembly includes at least one inclined surface that engages another surface.

If desired, the crane assembly can include a link assembly provided at each end of each transfer rail. In one embodiment, each link assembly comprise two connected links.

In another aspect an assembly is provided for moving a device along aligned racks. In the assembly, the device has synchronized gears, each gear being rotatable about an axis. A first rack and a second rack each have elements such as but not limited to teeth arranged to mate with the gears. An end of the first rack is disposed proximate an end of the second rack, and wherein elements proximate the aligned ends are modified from those elements further away from the aligned ends. In one embodiment, at least one of the width and/or the height of the elements of each rack is smaller in a direction toward the aligned ends. If desired, the modified elements of each of the racks in total correspond to a number of teeth on each gear.

As another aspect the foregoing assembly for moving a device along aligned racks can have one or more features described above or otherwise herein described and/or illustrated is also claimed.

Another aspect includes a hoist having a drum, a support shaft and a clutch mechanism operable coupled to the drum and the support shaft to allow relative rotational motion between the drum and the support shaft. An adjustment mechanism can be provided to adjust frictional forces of the clutch mechanism. The clutch mechanism can include a clutch plate engaging an inner surface of the drum, wherein in one embodiment the clutch plate includes a conically configured surface for engaging the drum.

In a further embodiment, the clutch mechanism further can include a second clutch plate configured to engage the drum, wherein in yet a further embodiment, the second clutch plate includes a conically configured surface at least partially facing the first-mentioned conically configured surface of the first-mentioned clutch plate. With two clutch plates, the adjustment mechanism can couple the first-mentioned clutch plate to the second clutch plate and is configured to pull the clutch plates together.

In another embodiment, the hoist can include a gear disposed about the support shaft and fixedly coupled to drum to rotate therewith independent of rotation of the support shaft.

In yet another aspect a drum for a hoist made is made stainless steel and heat treated at approximately 1850° F. surprisingly provides beneficial corrosion protection. If desired, an outer surface of the drum can be nickel plated.

In yet another aspect, a crane system includes a fixed runway and a rail. An extendable runway is moveable on the rail toward and away from the fixed runway, where the extendable runway is shorter than the rail. Two spaced apart drives selectively displace the extendable runway on the rail. Each drive is configured for displacing the extendable runway along a different portion of the rail. An extendable line is operably coupled to the extendable runway and the rail or another stationary position. The line extends to a different length for each position of the extendable runway on the rail. A position sensor is operably coupled to the extendable line to provide a signal indicative of a length of a portion of the line that has been extended.

### BRIEF DESCRIPTION OF THE DRAWINGS

FIG. 1 is a top plan schematic view of a crane system having pairs of rail assemblies and a pair of hoists movable thereon.

FIG. 2 is a front elevational view of the pair of hoist assemblies carrying a load.

FIG. 3 is a perspective view of a pair of movable transfer rails being brought into position.

FIG. 4 is a perspective view of a pair of transfer rails being locked into position.

FIG. 4A is a schematic side elevational view of a drive assembly for the hoist assembly.

FIG. 4B is a representative illustration comparing tooth profiles of individual teeth found on a drive rack.

FIG. 5 is a side elevational view of a spreader assembly.

FIG. 6 is a top plan view of the spreader assembly of FIG. 5.

FIG. 7 is a rear elevational view of the spreader assembly of FIG. 5 in an unlocked position.

FIG. 8 is a front elevational view of the spreader assembly of FIG. 5 in a locked position.

FIG. 9 is a perspective view of the spreader assembly of FIG. 5.

FIG. 10 an exploded view of the spreader assembly of FIG. 5.

FIG. 11 is an enlarged view of an end of a transfer rail and a locking assembly.

FIG. 12 is a top plan view of actuator assemblies to lift and lower a transfer rail.

FIG. 13 is a side elevational view of the assembly of FIG. 12.

FIG. 14A is a perspective view of a second locking assembly for the transfer rails.

FIG. 14B is a schematic side elevational view of the locking assembly and the transfer rail in a first position.

FIG. 14C is a schematic side elevational view of the locking assembly and the transfer rail in a second position.

FIG. 14D is a schematic side elevational view of locking assembly and the transfer rail in a third position.

FIG. 15 is a perspective view of a hoist assembly.

FIG. 16 is an exploded perspective view of a hoist assembly.

FIG. 17 is a side elevational view of a drum assembly.

FIG. 18 is a sectional view of the drum assembly taken along lines 18-18 in FIG. 17

FIG. 19 is an end view of the drum assembly.

FIG. 20 is an enlarged sectional view of a portion of the drum assembly.

FIG. 21 is a perspective view of the drum assembly.

FIG. 22 is an exploded view of the drum assembly.

FIG. 23 is an exploded view of a wire guide assembly for the drum assembly.

### DETAILED DESCRIPTION OF ILLUSTRATIVE EMBODIMENTS

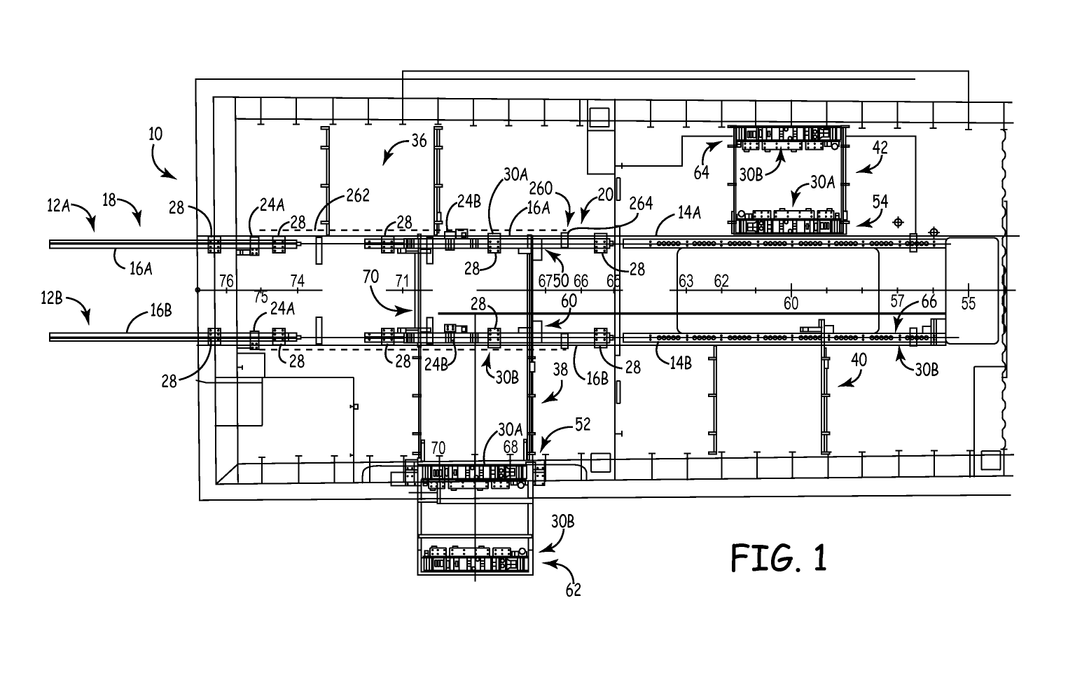

Aspects of the present invention relate to improvements for a crane and/or hoist system. Referring to FIG. 1, a crane system 10 is illustrated having a pair of runway assemblies 12A, 12B. In the embodiment illustrated, each runway or rail assembly 12A, 12B includes a fixed runway 14A, 14B and extendable runways 16A, 16B that can be selectively displaced longitudinally in line with its corresponding fixed runway 14A, 14B. In FIG. 1, the extendable runways 16A, 16B are illustrated in two different positions at 18 and 20. The extendable runways 16A, 16B ride upon guides 28 on fixed supports below the guides 28, while stationary drives 24A, 24B mounted to the rails 22A, 22B selectively drive the extendable runways 16A, 16B from guides 28 to guides 28. Drives 24A displace the extendable runways 16A, 16B to a cantilevered position illustrated at 18. For movement of the extendable runways 16A, 16B towards the fixed runways 14A, 14B, the extendable runways 16A, 16B will eventually engage drive 24B where upon drive 24B will then further displace the extendable runways 16A, 16B to a position that couples to the fixed runways 14A, 14B.

Various mechanisms can be used to drive the extendable runways 16A, 16B. In one embodiment, each of the stationary drives 24A and 24B can include a pinion gear wherein a drive rack is secured to each of the extendable runways 16A, 16B.

Hoist assemblies 30A, 30B are movable on the runways 14A, 14B and 16A, 16B as desired. In addition to movement on runways 14A, 14B and 16A, 16B, the hoist assemblies 30A, 30B can be transferred to transverse oriented runways indicated at 36, 38, 40 and 42. In this manner, the hoist assemblies 30A, 30B can be moved throughout the area of operation of crane 10 to relocate items. The crane system 10 is particularly useful for relocating items within a ship; however, it should be understood that aspects of the invention can be used in other operating environments and is not limited to use on a ship. In the embodiment illustrated in FIG. 1, position 18 for the extendable runway 16 corresponds to a cantilevered position such as out the stern of the ship, while transverse runways 38 can be used to position the hoist assemblies 30A, 30B in a cantilevered position outside the hull of the ship, herein illustrated on the starboard side.

As indicated above, the hoist assemblies 30A and 30B can be selectively positioned on the runways 14A, 14B and 16A, 16B as well as the various transfer runways, for example as illustrated at 38 and 42. By way of example, in FIG. 1 hoist assembly 30A is illustrated in three different positions at 50, 52 and 54, while hoist assembly 30B is illustrated in four different positions indicated at 60, 62, 64 and 66. Occasionally, it is necessary for a hoist assembly to transfer between the extendable runways 16A, 16B or the fixed runways 14A, 14B such as when hoist assembly 30A transfers from position 50 to position 52. In this situation, removable transfer rails 70 are positioned in between the runways 14A, 14B and 16A, 16B, respectively such as inline with the transverse runways such as indicated at 38.

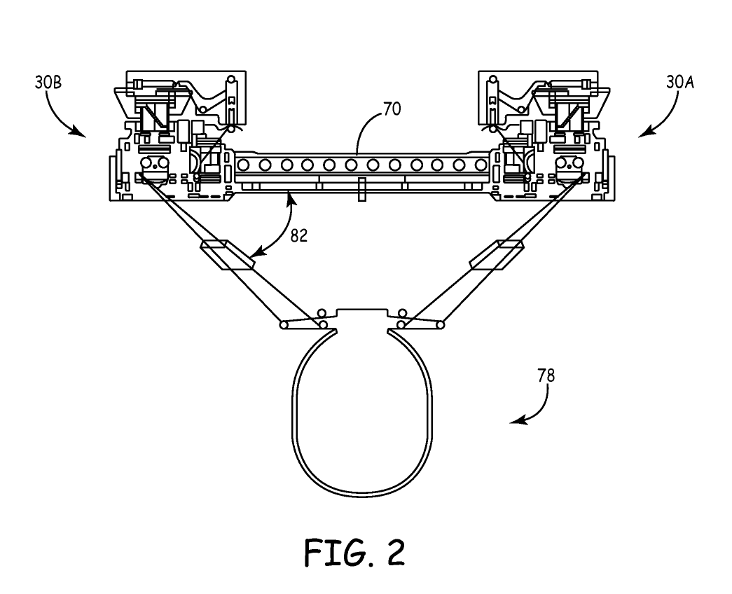

The hoist assemblies 30A and 30B can be used together or independently to lift various types of loads. One particular type of load that can cause problems is when the hoist assemblies 30A and 30B carry a load 78 jointly and between them as indicated in FIG. 2. For example as illustrated in FIG. 2, due to the lifting constraints of some types of loads such as load 78, the ropes 80 of the hoist assemblies 30A, 30B can form ever decreasing acute angles 82 (with respect to a plane defined by the rails) as the load 78 is lifted. These acute angles 82 create large lateral loads tending to pull the hoist assemblies 30A and 30B toward each other. Such loads can cause small deflections in the runways 14A, 14B, 16A, 16B and/or other components of the crane system 10 that can inhibit installation or removal of the removable transfer rails 70 between the runways 14A, 14B, 16A, 16B when desired.

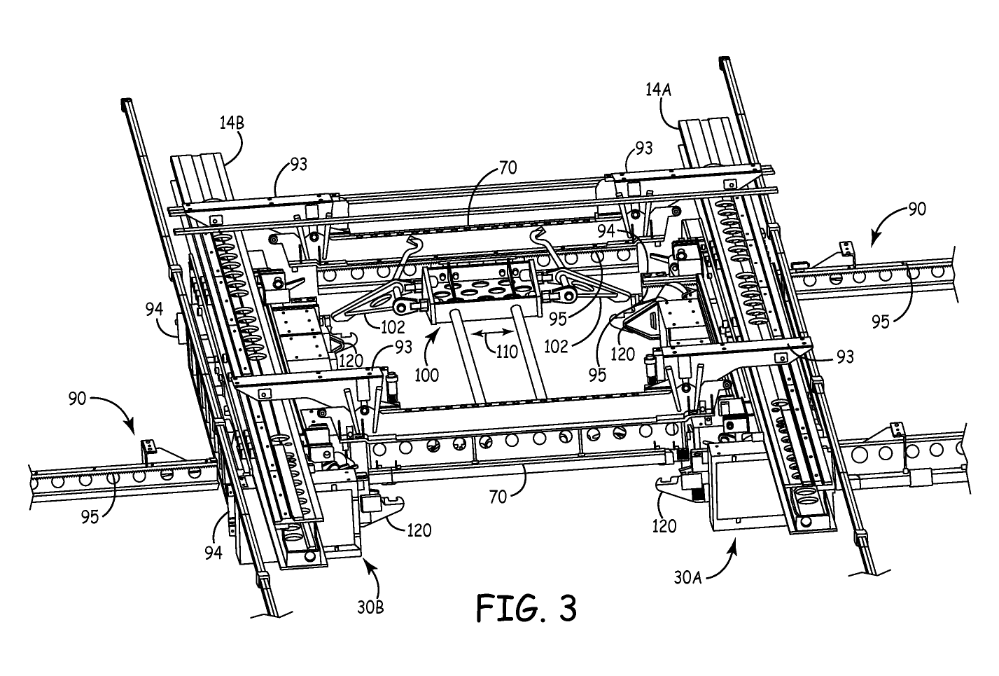

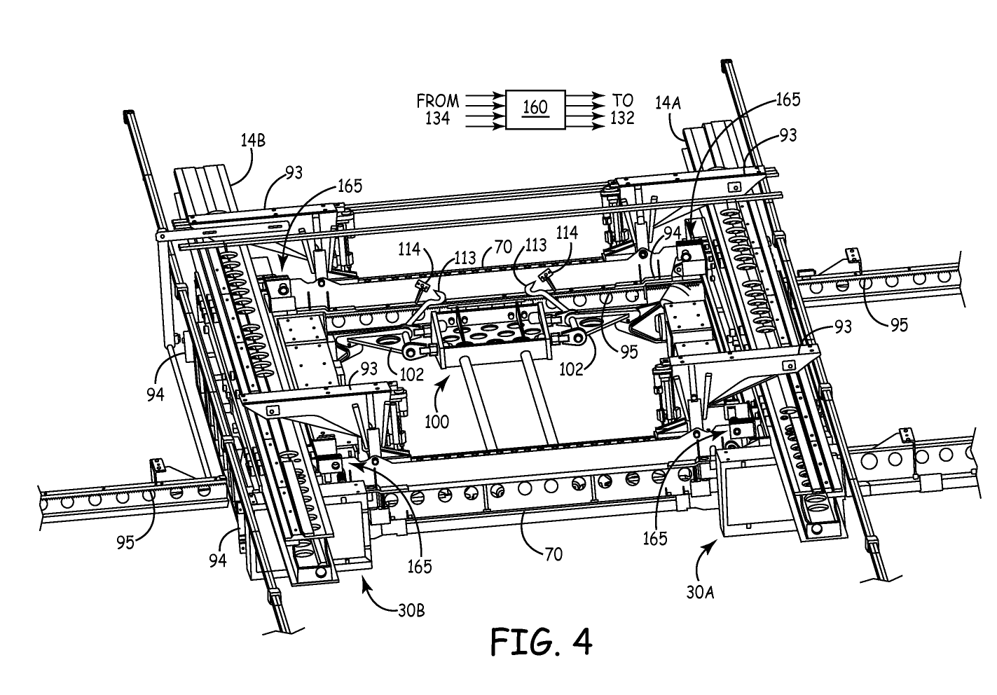

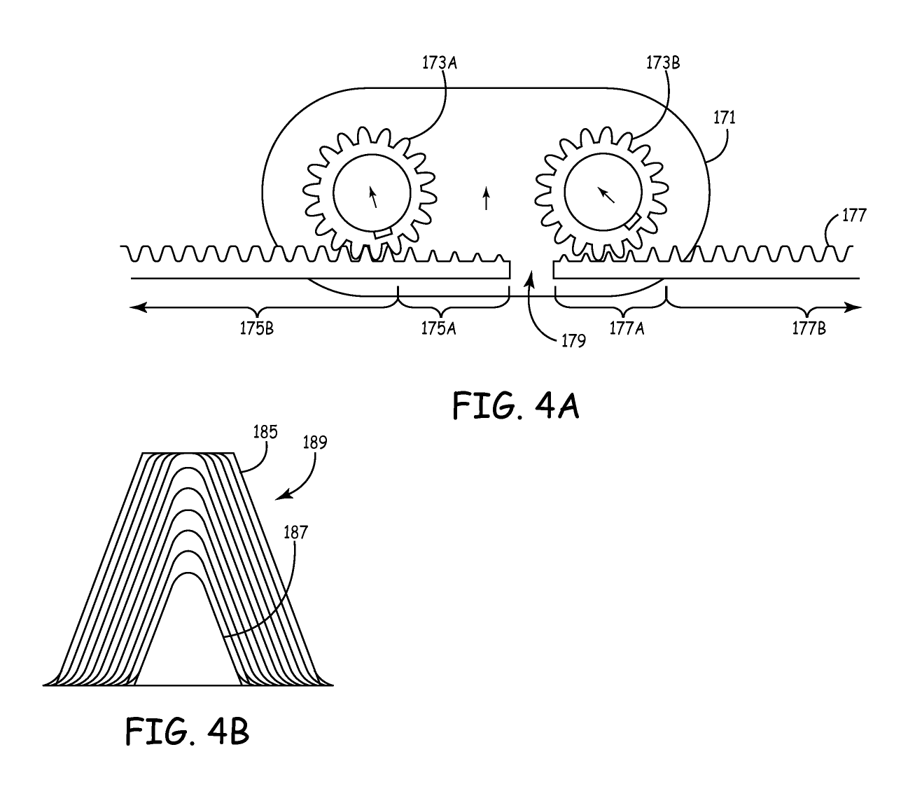

FIGS. 3 and 4 illustrate components of the assemblies described above with parts removed so as to reveal other components in greater detail. In FIG. 3 the hoist assemblies 30A, 30B are illustrated on portions of runways 14A, 14B where portions of stationary transverse rails 90 (for locations such as at 36, 38, 40 and 42) are also illustrated.

As indicated above, transfer rails 70 are selectively positioned between runways 14A, 14B and 16A, 16B to allow the hoist assemblies 30A, 30B to move transversely as needed with respect to runways 14A, 14B and 16A, 16B such as when they need to transition to the stationary transverse rails 90. Each of the transfer rails 70 are carried by supports 93 that in turn are carried by runways 14A, 14B and 16A, 16B. Although not shown, each of the supports 93 are coupled to trolleys that ride upon runways 14A, 14B and 16A, 16B. The transfer rails 70, supports 93 and trolleys coupled thereto can be moved into position by movement of the trolley hoist assemblies 30A, 30B when the trolleys of the transfer rails 70 are selectively coupled to thereto. Alternatively, the transfer rails 70, supports 93 and trolleys coupled thereto can be moved independently of the trolley hoist assemblies 30A, 30B.

It should be noted the trolley hoist assemblies 30A, 30B each carry at opposite ends thereof rail portions 94 that fill gaps between the transfer rails 70 and the stationary rails 90 when the transfer rails 70 are aligned with the stationary rails 90. When the transfer rails 70 are aligned with the rail portions 94 and the transverse stationary rails 90, portions of the hoist assemblies 30A, 30B are decoupled from those portions having the rail portions 94 such that the remaining portions of the hoist assemblies 30A and 30B can then be driven on the transfer rails 70, rail portions 94 and stationary transverse rails 90 as needed. Drive racks 95 are illustrated on stationary transverse rails 90, rail portions 94 and transfer rails 70, which of course would be aligned so as to allow movement of the trolley hoist assemblies 30A, 30B.

A general description is provided above for the runways 14A, 14B, 16A, 16B, trolleys 30A and 30B and transverse rails 90 since these components do not form aspects of the present invention; however, aspects of the invention can be used on crane system such as the crane system 10 described above.

To enable easy insertion and removal of the removable transfer rails 70 a spreader assembly 100 illustrated in FIGS. 3 and 4 is used to push the trolley hoist assemblies 30A and 30B away from each other against the lateral loads tending to draw the trolley hoist assemblies 30A and 30B together. By pushing the trolley hoist assemblies 30A and 30B away from each other, sufficient distance can be created between the extendable rails 16A, 16B or fixed runways 14A, 14B so as to allow the removable transfer rails 70 to be inserted therebetween. In general, the spreader assembly 100 includes one or more devices that are positioned between the trolley hoist assemblies 30A, 30B so as to create a force that pushes the trolley hoist assemblies away from each other. The spreader assembly can be configured with various arrangements of actuator(s) with and without links to accomplish this function. In the exemplary embodiment, one or more pivotable link(s) 102 are arranged so as to pivot and thereby increase the effective length of the link(s) 102 in the horizontal plane between the trolley hoist assemblies 30A, 30B to force the trolley hoist assemblies 30A, 30B away from each other. Various actuator arrangements can be used to cause pivoting movement of the link(s) 102 so as to create a force that pushes the trolley hoist assemblies 30A and 30B away from each other. In the exemplary embodiment, the actuators (described below) used to raise and lower the transfer rails 70 cause pivoting movement of the link(s) 102; however in an alternative embodiment, a dedicated actuator or actuators of the spreader assembly 100 operating directly upon the trolley hoist assemblies 30A, 30B (or otherwise against portions of the runways 14A, 14B, and 16A, 16B) or coupled to the link(s) 102 can be used.

Generally, the spreader assembly 100 includes a first portion that engages one of the trolley hoist assemblies, for example, trolley 30A, while another portion of the spreader assembly, such as the one or more links 102 illustrated, engage the trolley hoist assembly 30B. In the embodiment, illustrated the first portion of the spreader assembly 100 also includes one or more pivotable links 102; however, other types of blocks, rods and the like can also be used. It should also be noted that in an alternative embodiment, the one or more links 102 can operate between portions of the spreaders assembly 100 that contact the trolley hoist assemblies 30A, 30B. In other words it is not necessary that the link(s) 102 directly engage one or more of the trolley hoist assemblies 30A, 30B.

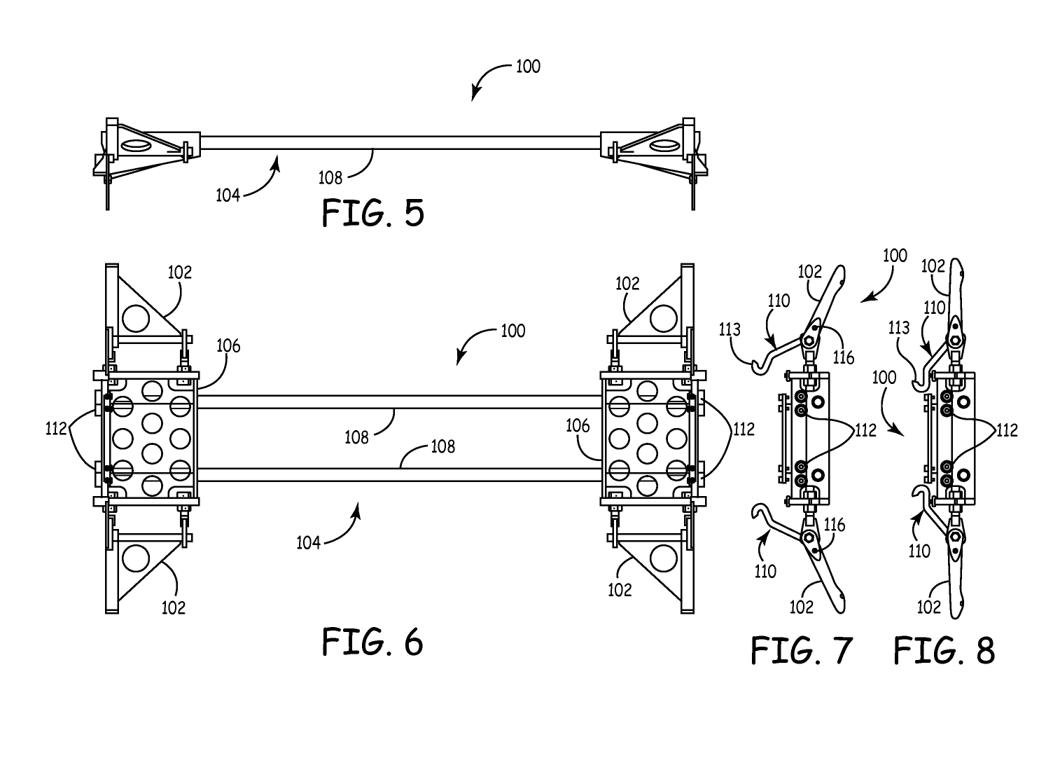

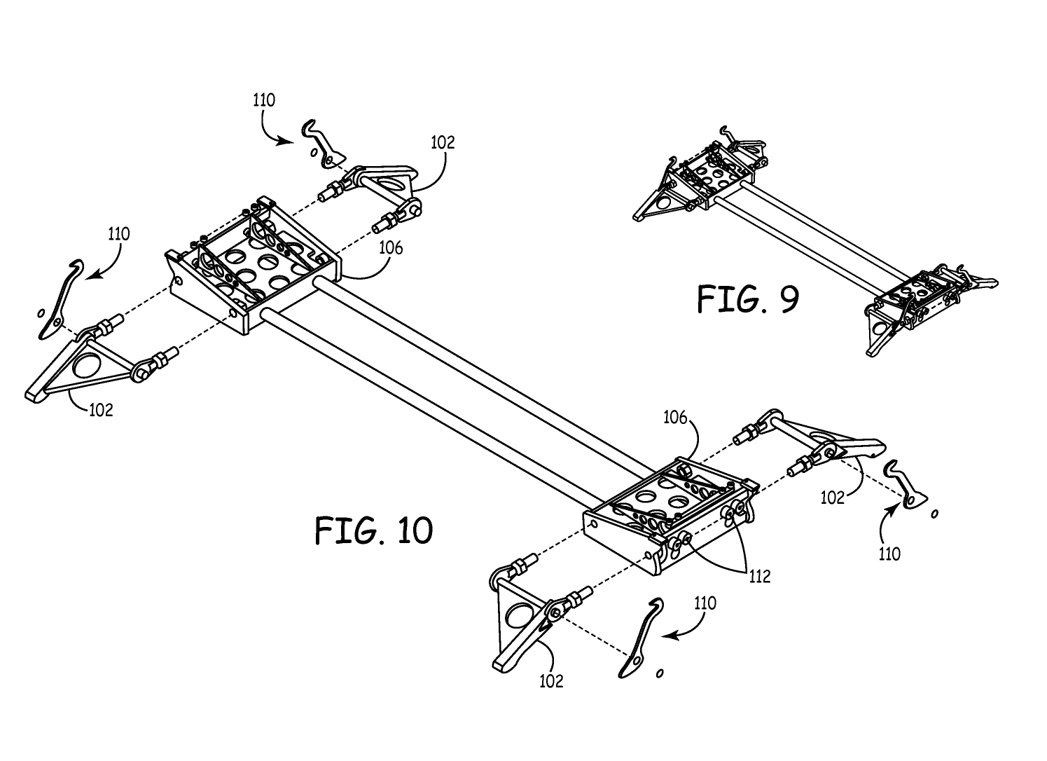

Referring to FIGS. 5-8, the spreader assembly 100 includes a support structure 104 to which the one or more links 102 is operatively coupled. Support structure 104 can take any number of forms as appreciated by those skilled in the art. In the exemplary embodiment, the support structure 104 includes a pair of ridged frame supports 106 to which the links 102 are attached. Elongated connecting elements 108, for example, tubes, join the frame supports 106 together. If desired, the connecting elements 108 could be stiff or ridged; however, in the exemplary embodiment, the connecting elements 108 allow some lateral displacement (indicated by double arrow 110 in FIG. 3) of one of the frame supports 106 relative to the other frame support 106, which can be beneficial during insertion of the transfer rails 70. It should be noted that it is beneficial to create spaced-apart forces near the ends of one or more of the trolleys 30A, because such forces cause the trolley hoist assemblies 30A and 30B to become parallel. The spaced-apart links 102 are one exemplary embodiment for creating such forces.

Each of the frame supports 106 include guide rollers 112 that engage corresponding portions of the transfer rails so as to allow each of the frame supports 106 to traverse the removable transfer rails 70 as desired with movement of the trolley hoist assemblies 30A and 30B. The rollers 112 would also engage the rail portions 94 and transverse runways 90

When the spreader assembly 100 is operatively engaged with the trolley hoist assemblies 30A, 30B, the spreader assembly 100 travels with the trolley hoist assemblies 30A, 30B on the transfer rails 70 and transverse runways 90 and reacts the lateral load tending to pull the trolley hoist assemblies 30A, 30B toward each other. In the illustrative embodiment, the spreader assembly 100 is fixedly coupled to the transfer rails 70 with couplers 110 when the spreader assembly is not coupled to the trolley hoist assemblies 30A, 30B. Couplers 110 include pivoting hooks 113 that selectively engage pins 114 (FIG. 4) provided on the transfer rails 70. In the illustrative embodiment, pivoting motion of the hooks 113 is controlled by movement of a nearby link 102 in that a pin 116 couples the hook 113 to the corresponding link 102 and is arranged so that when the mass of the link 102 pulls the link 102 downwardly, the link 102 causes the hook 113 to engage the pin 114. This situation occurs when the links 102 are not in contact with the trolley hoist assemblies 30A, 30B. Engagement of the hooks 113 with the pins 114 thereby inhibits lateral movement of the spreader assembly 100 relative to the transfer rails 70. In contrast, when the links are operatively coupled to the trolley hoist assemblies 30A, 30B so as to create a spreading force, each link 102 pivots upwardly thereby pivoting the hook 113 so as to release from its corresponding pin 114. It should be understood that the spreader assembly 100 is not limited to use of four links 102 with four hooks 113 and associated pins 114, wherein the aspects herein described can be operatively configured for use with one or more links. Likewise, other forms of coupling mechanisms, for example comprising other types of locking elements with or without actuators, can be used to selectively couple the spreader assembly 100 to the transfer rail(s) 70.

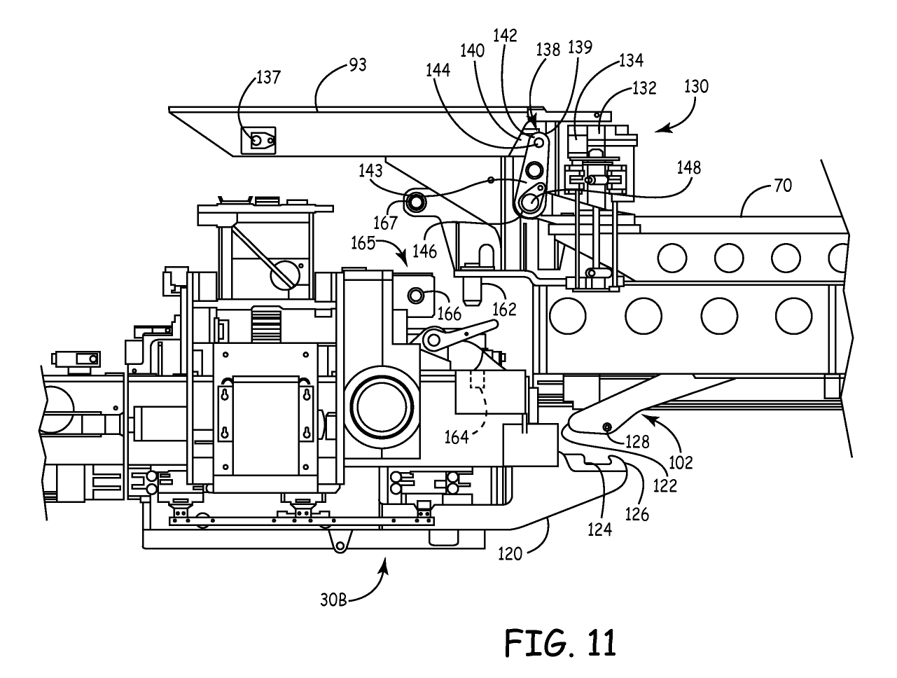

FIG. 11 illustrates engaging elements of a link 102 with trolley hoist assembly 30B. Receivers 120 are disposed on each of the trolley hoist assemblies 30A, 30B to receive a portion of the corresponding link 102. Complementary surfaces of the receiver 120 and the link 102 engage each other. In the embodiment illustrated, the link 102 includes a rounded bearing surface 122 that is received in an aperture 124, the bearing surface 122 and surfaces of the aperture 124 being configured so as to spread the trolley hoist assemblies 30A, 30B apart. In a further embodiment, the link 102 also includes complementary surfaces that can be used react tension between the spreader assembly 100 and the trolley hoist assemblies 30A, 30B. In the exemplary embodiment, these complementary surfaces comprise a hook 126 provided on the receiver 120 and a transverse pin 128 provided on the link 102, although if desired the locations of the hook 126 and pin 128 can be reversed. Likewise, other forms of elements having complementary surfaces can be used. Being able to lock the link 102 with the receiver 120 so as to react tension loads is helpful, for example, in the event one of the trolley hoist assemblies is cantilevered outwardly over the water as illustrated when the trolley hoist assemblies 30A, 30B are being used in transverse runways at location 38, and it becomes necessary to manually move the trolley hoist assemblies 30A, 30B on the transverse runways. In such a situation, the innermost trolley hoist assembly can be pulled upon while the spreader assembly 100 then pulls upon the outermost trolley hoist assembly due to the complementary locking surfaces for creating tension.

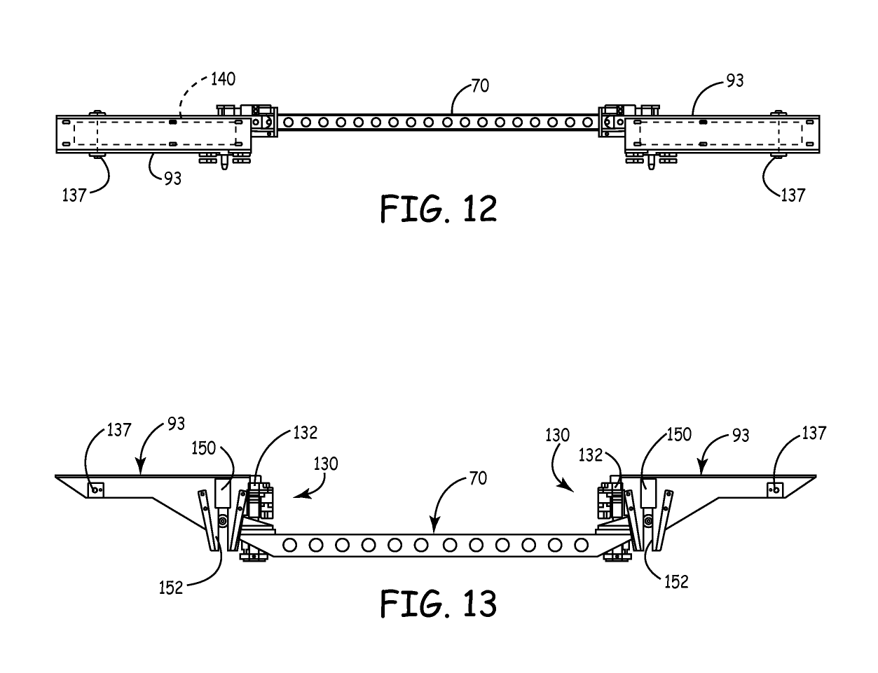

FIGS. 11-13 illustrate actuator assemblies 130 to lift and lower a transfer rail 70. Each actuator assembly 130 is operatively coupled between support 93 and an end of the transfer rail 70 and includes an actuator 132 and a position sensor 134 to sense the vertical position of each corresponding end of the transfer rail 70. Each end of the transfer rail 70 is further coupled to support 93 through a link assembly 138 to carry and react loads such as torsion loads rather than through the actuator 132. Link assembly 138 includes a first link 140 pivotally connected to support 93 with a transverse pin 137 at a location remote from the end of the transfer rail 70. A second end 139 of link 140 remote from pin 137 is coupled to a first end 142 of second link 143 with a transverse pin 144. A second end 146 of link 142 is pivotally connected to the transfer rail 70 with a transverse pin 148. Vertical movement of the end of the transfer rail 70 is controlled by a guide block 150 sliding in a guide slot 152.

Actuator 132 can take the form of a hydraulic, pneumatic, electric or electromechanical (e.g. screw drive) actuator. As indicated above, in this exemplary embodiment, the actuators 132 provide downwardly directed force upon the transfer rails 70 so as to operate the spreader assembly 100 as described above. Hence each of the actuators 132 is rated to provide sufficient down force to install the transfer rail 70, and sufficient up force, when necessary to remove the transfer rail 70. It should be noted in the exemplary embodiment, each of the links 102 are locked in position due to movement to an over-center displacement. The actuators 132 are operated based on command signals provided from a controller 160 that receives signals from each of the position sensors 134. The controller 160 operates the actuators 132 so as to lower and raise the transfer rails 70 without binding.

Various forms of mechanisms can be used to align ends of each of the transfer rails 70 with hoist assemblies 30A and 30B and couple the transfer rails 70 to the hoist assemblies 30A, 30B. In FIG. 11 an aligning pin 162 mates with an aperture in pin receiver 164 at each end to align the transfer rails 70. When the aligning pin 162 and pin receiver 164 have mated, controller 160 operates a locking assembly 165 (see also FIG. 4) provided on ends of hoist assemblies 30A, 30B having a pin and aperture connection. Herein, a pin 166 is slid to mate with an aperture 167 in the end of transfer rail 70, the pin 166 being displaced by a suitable actuator in the locking assembly. If desired, the pin can be stationary and the actuator can displace an element having the aperture.

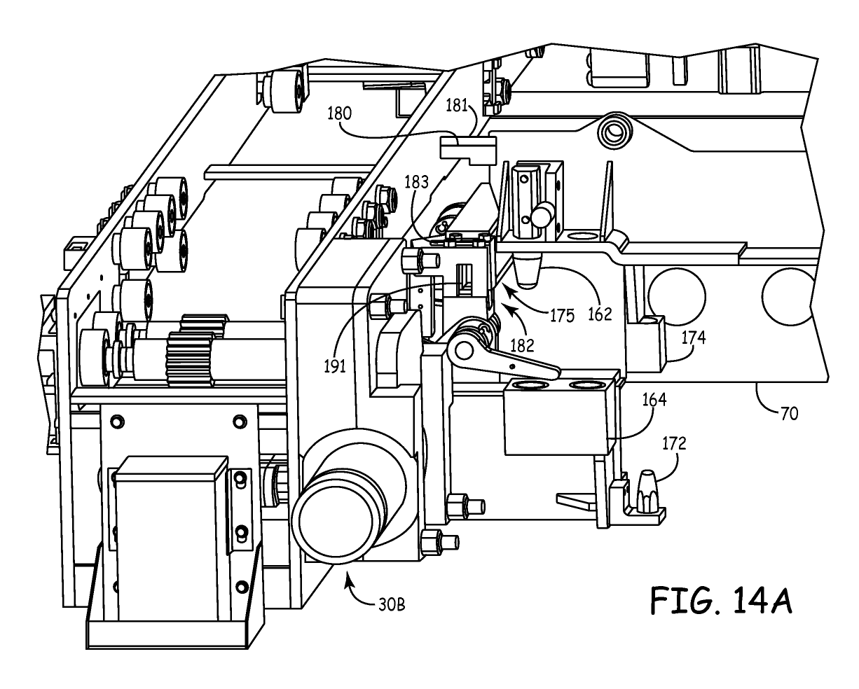

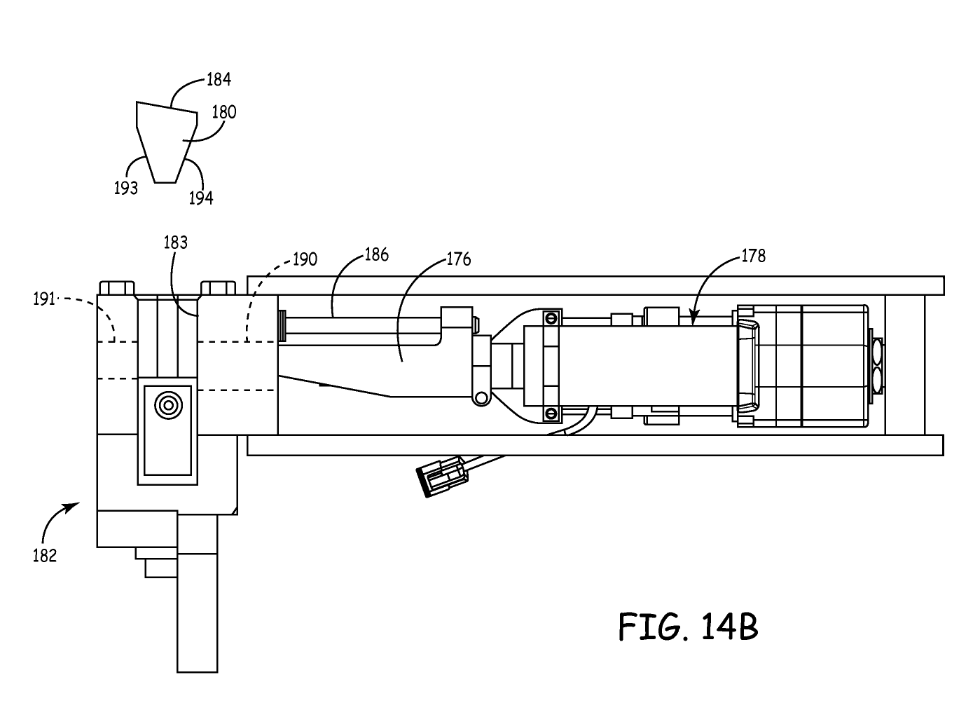

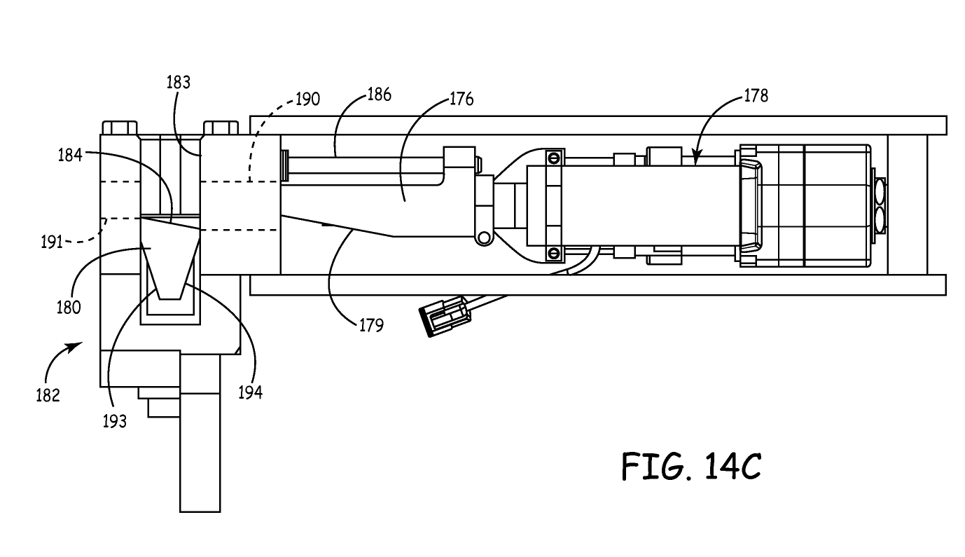

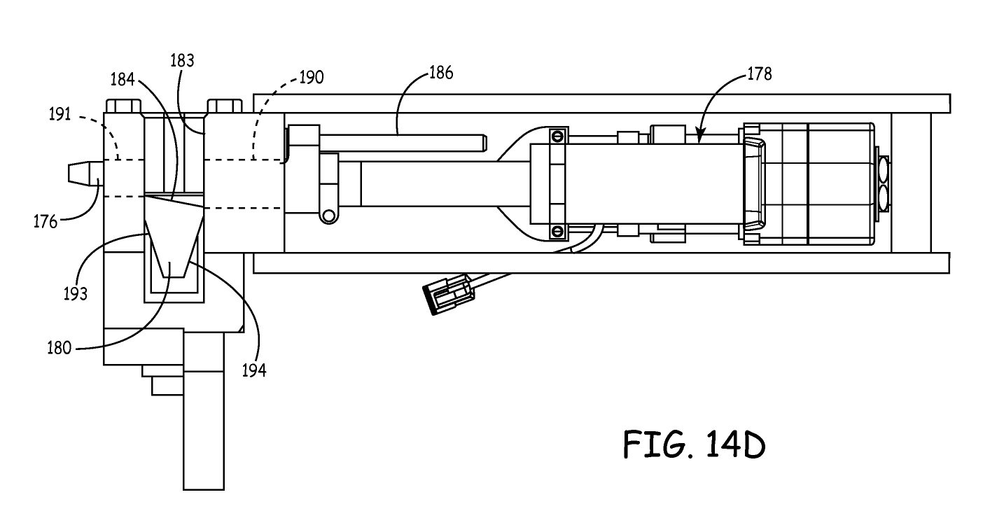

A second embodiment of an aligning and coupling mechanism for coupling the transfer rails 70 and the hoist assemblies 30A, 30B is illustrated in FIGS. 14A-14D, wherein in each of these figures, portions have been for purposes of clarity and understanding. Referring first to FIG. 14A, two spaced apart pin and pin receiver assemblies are used between each end of transfer rails 70 and corresponding hoist assembly 30A or 30B. Use of two spaced apart pin/pin receiver assemblies provides increased stiffness. In particular, besides pin 162 and pin receiver 164 as described above, a second pin 172, herein provided on hoist assembly 30B, and pin receiver 172, herein provided on transfer rail 70 are also used.

A second embodiment of a locking assembly 175 for locking each of the transfer rail to the hoist assembly 30A or 30B is also illustrated. Locking assembly 175 includes a suitable actuator 178 for selectively displacing a locking pin 176 having an inclined engaging surface 179 that engages an element, herein projection 180 disposed on the end of the transfer rail 70. In particular, the inclined engaging surface 179 engages an upwardly facing surface 181 of the projection 180 so that upward movement of the end of the transfer rail 70 is prevented. A receiver 182 mounted to hoist assemblies 30A and 30B includes an upwardly facing aperture 183 that receives projection 180. Referring also to FIGS. 14B, 14C and 14D where projection 180 is illustrated by itself for purposes of understanding the operation of the locking assembly 175 (but represents also the transfer rail 70), when the projection 180 is received by receiver 182, the actuator 178 displaces the pin 176 over the projection 180 thereby preventing upward movement. If desired, the projection 180 can include a complementary, upwardly facing, inclined surface 184 such that a downward force on the transfer rail 70 is created when the pin 166 slides across the inclined surface 184 of projection 180 and to further inhibit upward movement of the transfer rail 70. It should be noted a guide mechanism herein a guide rod 186 can be provided to guide pin 176 during movement thereof. Guide rod 186 is secured to receiver 182. In addition, receiver 182 can include aperture(s) 190, 191 through which pin 176 can be extended through when pin 176 engages projection 180. In this manner, upward movement of the transfer rail is also inhibited by contact of an upper surface of the pin 176 with walls of the aperture(s) 190, 191. It should also be noted inclined side surface(s) 193, 194 can be provided on the projection 180 to aid its guidance into receiver 182.

When the removable transfer rails 70 are secured in position so as to be aligned with the transverse runways 90, drive racks on the removable transfer rails 70 are substantially aligned with drive racks on portions 94, while drive racks on portions 94 are substantially aligned with drive racks 95. When aligned as such, typically there are gaps between each of the aligned drive rack pairs. Preferably, it is desired that the drive racks be aligned such that the tooth spacing is constant across the gap where the gap distance between the racks accounts for an integer number of teeth, for example, one missing tooth. This allows the drive sprocket or pinion gear to easily transition between the drive racks and, in particular, over each of the gaps between the drive racks without binding or otherwise misaligned contact between the pinion gear and the drive racks. However, ensuring such accuracy is difficult. If the gap distance between adjacent drive racks does not amount to one (or an integer number of teeth), the pinion gear approaching the gap would travel over the gap, or begin traveling over the gap, but then not properly mate with the teeth of the drive rack on the next rail. Worse yet, if the pairs of adjacent rails such as transfer rails 90 were not aligned with each corresponding portion 94, the pinion gear on one side of the hoist assemblies 30A and 30B may mate correctly with the drive racks thereon, while the pinion gear on the other side of the hoist assemblies 30A and 30B does not mate correctly with the drive racks.

FIG. 4A schematically illustrates a drive mechanism 171 on one side of hoist assembly 30A or 30B that includes two drive sprockets or pinion gears 173A and 173B that mate with drive racks 175 and 177, which represent the drive racks on transfer rails 90 and portions 94, or portions 94 and removable transfer rails 70. The gears 173A and 173B have rotational axes that are fixed relative to each other and are operably coupled to the same gear box such that they rotate at the same speed in synchronism with each other. As will be seen below, the use of two synchronously rotating gears is advantageous because as one gear is traveling over the gap 179 between the drive racks 175 and 177 the other is mated securely with one of the drive racks 175 and 177. The gears 173A and 173B can be driven so as to move a device, herein by example, a hoist assembly. However, in another embodiment the gears 173A and 173B and gear box are not driven, but rather guide a device along the racks 175 and 177.

In the aspect of the invention illustrated in FIG. 4A, portions 175A and 177A of each of the drive racks 175 and 177 closest to aligned ends of the drive racks 175 and 177, or the gap 179 therebetween (if present), have tooth profiles that do not match with the tooth profile of the drive racks 175 and 177 when the pinion gears 173A and 173B properly mate therewith such as in portions 175B and 177B. In particular, the tooth profile in portions 175A and 177A are “modified” such that at least the width of each tooth in portions 175A and 177A is less than width of each tooth in portions 175B and 177B. This effectively increases the spacing between adjacent teeth in portions 175A and 177A (by increasing the distance between opposed contact surfaces of adjacent teeth) over the spacing between adjacent teeth in portions 175B and 177B. Stated another way, the backlash between the gears 173A and 173B is greater in the portions 175A and 177A than that in the portions 175B and 177B. This increased spacing or backlash allows the gears 173A and 173B to travel over portions 175A and 177A even if misalignment is present. This is because the increased teeth spacing in portions 175A and 177A allows the teeth of the gears 173A and 173B to still fall between the teeth of portions 175A and 177A and thus roll easily.

Although maybe not necessary in every embodiment, modified teeth in portions 175A and 177A of the exemplary embodiment illustrated have a height that is less than the height of each tooth in portions 175B and 177B. This again allows the gears 173A and 173B to roll easily in portions 175A and 177A if some misalignment between the racks 175 and 177 is present.

In yet another embodiment, if desired, the widths and/or heights of the modified teeth in portions 175A and 177A may vary relative to each other, and in particular, as illustrated where the widths and/or heights of the teeth get smaller in a direction toward each end of the aligned drive racks 175 and 177. Although in the illustrated embodiment, each tooth in portions 175A and 177A gets smaller (decreased width and/or height) in a direction toward the end of each respective drive rack 175 and 177, in another embodiment, teeth of one or more adjacent pairs may be substantially identical to each other, while the overall tooth width and/or height generally decreases in a direction toward the ends of the drive racks 175 and 177.

It should be noted, if desired, the depth of each tooth (the distance orthogonal to the width) can also decrease generally tooth to tooth in a direction toward the end of each drive rack 175 and 177 in any manner similar to the width and/or the height as described above, although such modification of tooth profile may not be needed in many embodiments. Nevertheless, it should be understood references to the width and/or height changing in the exemplary embodiment should not be considered limiting in that the depth of one or more teeth in portions 175A and 177A can be less than a tooth in portions 175B and 177B and/or decrease in depth in a direction toward the end of each drive track 175, 177.

Referring back to the illustrated exemplary embodiment of FIG. 4A, the width and/or the height can change in a linear manner (i.e. with the width and/or the height changing from tooth to tooth in equal amounts), or in a non-linear manner (i.e. with the width and/or the height changing from tooth to tooth in unequal or differing amounts). FIG. 4B schematically illustrates ten teeth superimposed on each other in order to illustrate that the width, and sometimes the height, from tooth to tooth changes in equal amounts. For example with reference to FIG. 4A, tooth 185 would correspond to a tooth in portion 175B or 177B, while tooth 187 would correspond to the tooth closest to the end of the drive rack 175 or 177 in portions 175A and 177A. As can be seen from this schematic illustration the width of each of the teeth 189 between tooth 185 and tooth 187 gets thinner in equal amounts. Similarly, the height also decreases for some of the teeth 189 between 185 and 187, and in this example, if it does change, it changes by an equal amount. If desired, the incremental changes between teeth corresponds to the number of teeth on gears 173A, 173B. For example, if there are ten teeth on each of gears 173A and 173B, then the incremental changes between teeth in portions 175A and 177A can occur over ten teeth. However, again, this is but one exemplary embodiment on how the profile of the teeth in portions 175A and 177A can change.

As further illustrated in FIG. 4A, the length of each portion 175A or 177A does not substantially exceed the distance between the rotational axes of gears 173A and 173B. In this manner, when also the width and/or the height of the teeth in each portion 175A and 175B also generally decreases in a direction toward each end of each corresponding drive rack 175 and 177, one of the gears 173A or 173B mates better (i.e. less backlash) than the gear traversing from one drive rack to the other and over the gap 179, if present. In yet another embodiment, the combined length of portions 175A and 177A is substantially equal to the distance between the axes of gears 173A and 173B. In general, the length of portions 175A and 177A can be related to the amount of possible misalignment that can or is expected to occur between drive racks 175 and 177. Likewise, the extent of difference (width, height and/or depth) in the profile from tooth to tooth in portions 175A and 177A can be related to the amount of possible misalignment that can or is expected to occur between drive racks 175 and 177.

Although illustrated in the exemplary embodiment where modified teeth are present at aligned ends of the straight or flat drive racks 175 and 177, this should not be considered limiting for modified teeth can be used on aligned ends of curved drive racks, if desired. In addition it should be noted that using modified teeth as herein described is but one form of element arranged on a rack to mate with the gear. For example, modifying the width and/or height of any suitable element on a rack such as spaced apart rods that engage the gears can also be used. In such an example, for instance the diameter of the rods proximate the ends of the racks can get smaller in a direction toward the end of the rack.

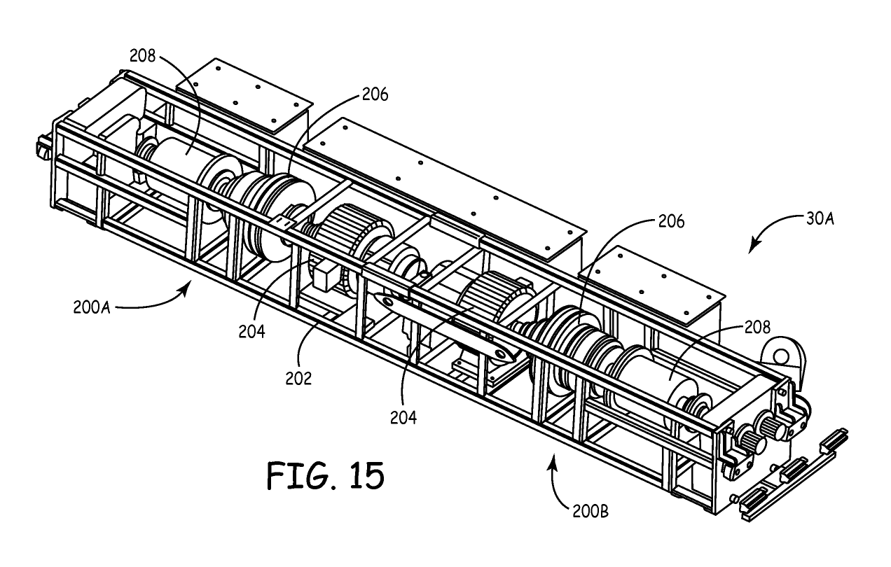

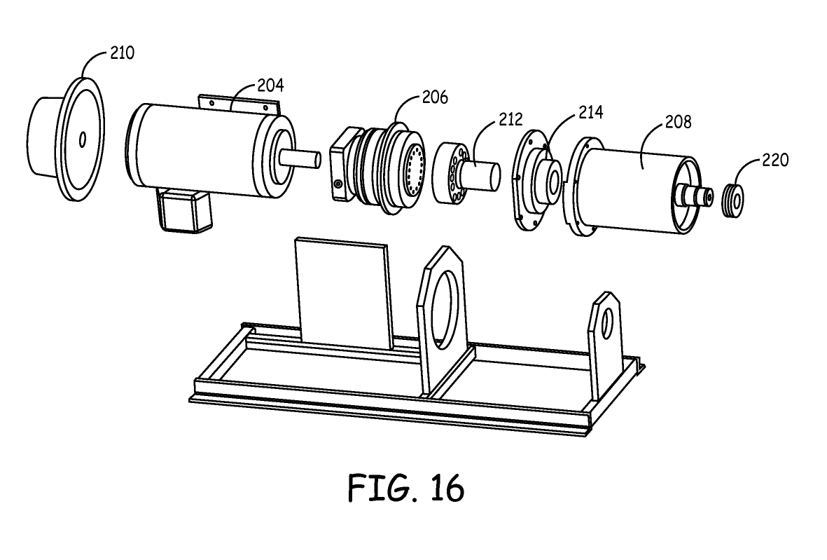

Portions of trolley hoist assembly 30A are illustrated in FIG. 15. Trolley hoist assembly 30A includes hoists 200A and 200B mounted in a support structure 202. Each hoist 200A, 200B includes a drive motor 204 coupled to a gear reducer 206 that, in turn, is coupled to a drum assembly 208. Further components of hoists 200A, 200B are illustrated in the exploded view of FIG. 16. A brake assembly 210 is operatively coupled to the drive motor 204/drum assembly 208, herein coupled to drive motor 204 on an end opposite gear reducer 206. Connection of the gear reducer 206 to the drum assembly 208 includes a shaft adapter with integrated tension sensor 212 and a barrel coupling 214 with dowels 215 for coupling gear reducer 206 to drum assembly 208. A support bearing 220 is provided on an end of drum assembly 208 opposite barrel coupling 214.

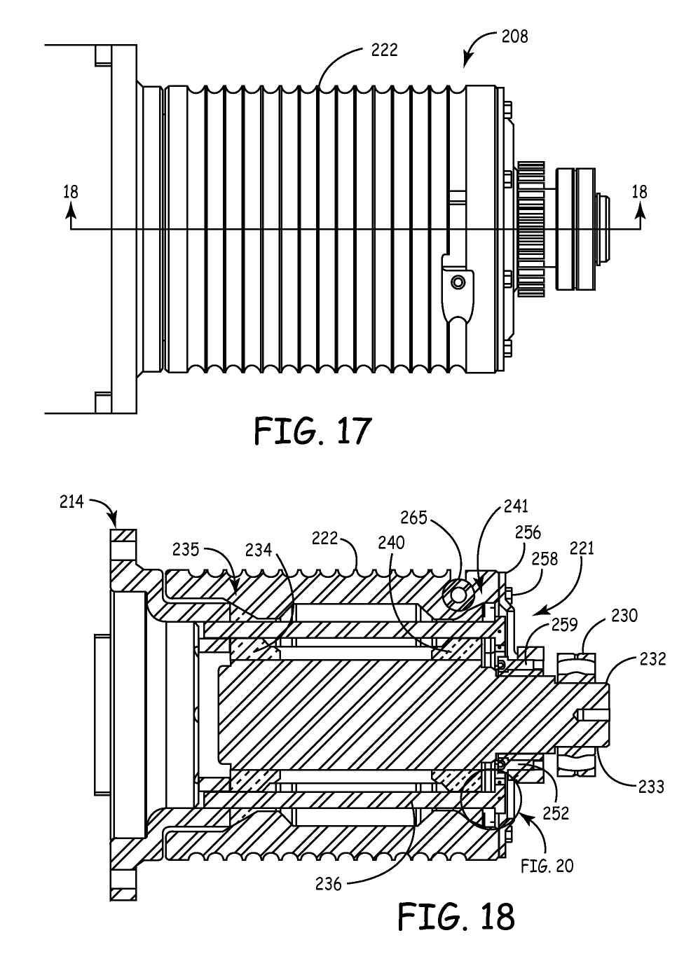

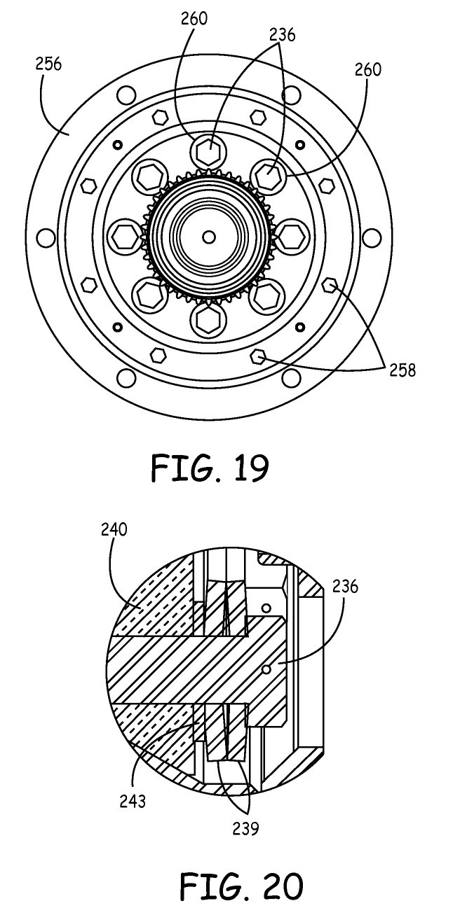

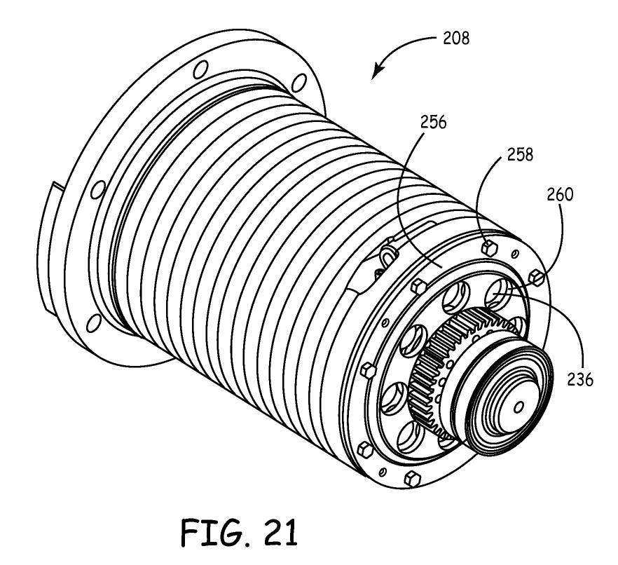

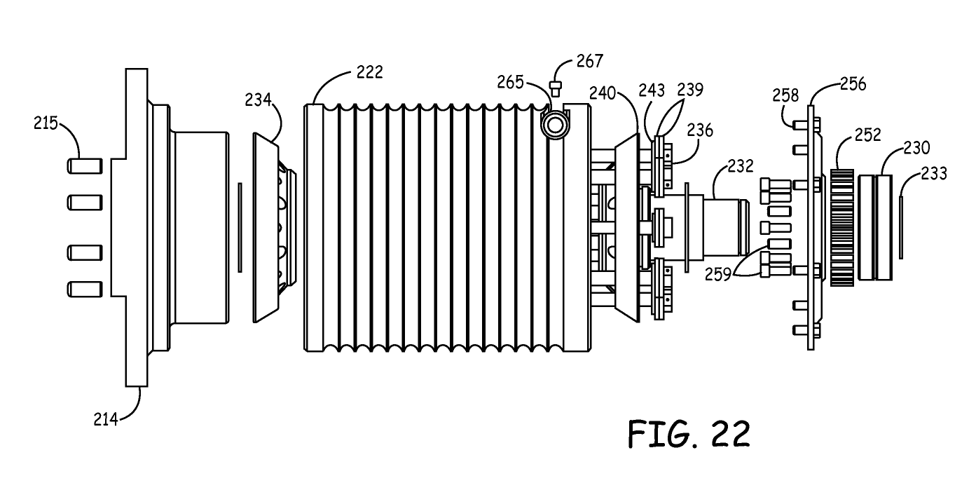

Construction of drum assembly 208 is illustrated in FIGS. 17-22. A particularly beneficial feature of drum assembly 208 is the ability of drum assembly 208 to respond to overload conditions such as when tension loads on the wire rope increase suddenly. In these conditions, the drum assembly 208 will payout wire rope without the necessity of the drive motor 204 and/or gear reducer 206 from quickly rotating in a direction so as to payout wire rope, a requirement that would be difficult to achieve from such components.

Drum assembly 208 includes a clutch mechanism 221 that allows a drum 222 to rotate, if necessary, independently coupled to the state of operation of drive motor 204 and/or gear reducer 206 be it rotating or stationary. In other words, clutch mechanism 221 is operatively coupled between a component fixedly coupled to rotate with gear reducer 206 and drum 222, as illustrated, or a component fixedly coupled to rotate with drum 222. Referring to FIG. 18, in the exemplary embodiment, barrel coupling 214 is fixedly coupled to support shaft 230 to rotate therewith via a clutch plate 234. Support bearing 220 is mounted on an end of the support shaft 232 with a retainer 233. To enhance coupling of the clutch plate 234 to the support shaft 232 both components can include complementary engaging surfaces such as longitudinal splines. A plurality of fasteners 236 maintains a rigid connection of clutch plate 234 to barrel coupling 214. In this exemplary embodiment, the clutch plate 234 bears directly against an inner surface of drum 222, herein where the engaging friction surfaces indicated at 235 are conically configured.

In the exemplary embodiment illustrated, the clutch mechanism 221 further includes a second clutch plate 240 coupled to support shaft 232 to rotate therewith, which, if desired, can be splined as described above. Clutch plate 240 can also bear directly against drum 222 on conically configured engaging surfaces indicated at 241. Fasteners 236 extend through apertures in the second clutch plate 240. In the embodiment illustrated, the bearing surfaces of clutch plates 234 and 240 can be oriented to face, or generally face each other. In this manner, friction between the engaging surfaces of the clutch plates 234 and 240 at 235 and 241, respectively, is adjustable by tightening of the fasteners 236. Compliant elements such as Belleville washers 239 are disposed under the heads of each of the fasteners 236 to maintain tension forces in fasteners 236. A hardened or high strength washer 243 can be disposed between the second clutch plate 240 and a Bellville washer for each fastener 236. In addition, orientation of the engaging surfaces of the clutch plates 234 and 240 to generally face each other also maintains the drum 222 in a fixed longitudinal position along the axis of support shaft 230.

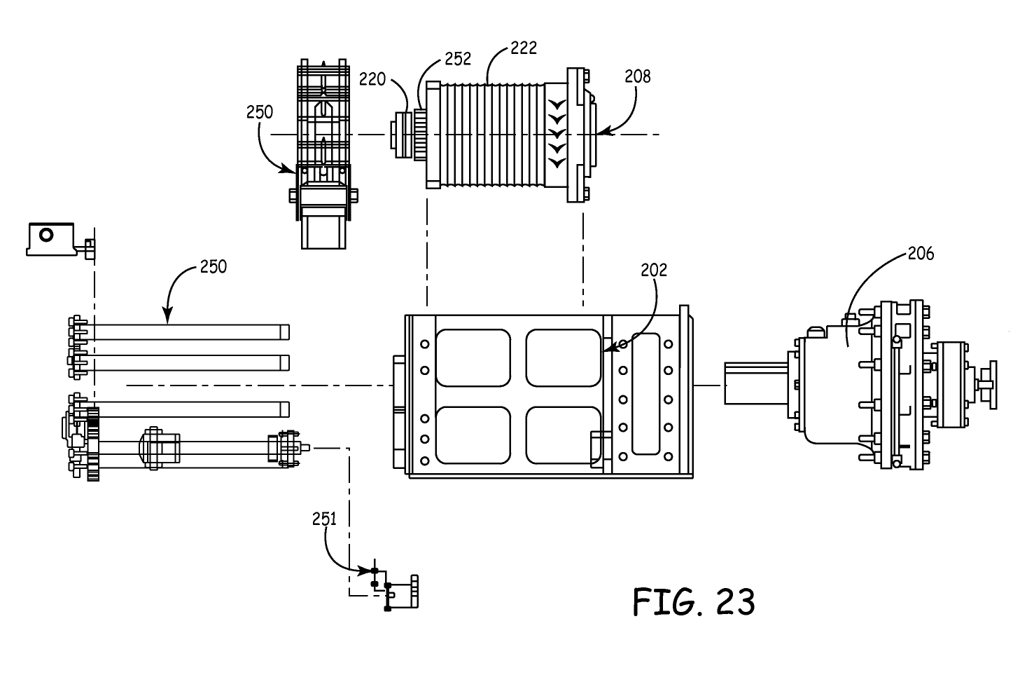

A wire rope guide assembly 250 (FIG. 23) well known in the art guides the wire rope onto the helically grooved drum 222 and includes an encoder 251 for monitoring position thereof. Commonly such guide assemblies are driven by a gear provided on the support shaft; however, since drum 222 can rotate independently of support shaft 232, a gear 252 used to drive guide assembly 250 is inventively coupled to rotate with drum 222. In the exemplary embodiment illustrated, an adapter plate 256 is fastened to drum 222 with fasteners 258, while gear 252 is fastened to adapter plate 256 with dowels and fasteners 259. Clearance is provided between gear 252 and support shaft 230. Access holes 260 in adapter plate 256 are aligned with fasteners 236 so as to allow adjustment of clutch mechanism 221. A counter bored cable swage 265 and set screw 267 is provided in the drum 222 so that the wire rope lays flat on the surface of the drum 222.

In one embodiment, materials for drum 222 and other components are inventively chosen to advantageously operate in a salt spray environment. In particular, drum 222 can be made of 416 stainless steel, which typically is not very corrosion resistant but has good machining properties and good resistance to galvanic action. However, by heating the drum 222 to the upper end of the austenitizing range for 416SST (approximately 1850° F.) for approximately 1 hr 40 min. and then nitrogen quenched to room temperature or cooler, corrosion resistance is obtained. Such a process applied to a drum application is believed inventive. To further improve corrosion protection, surfaces of drum 222 can be nickel plated (e.g. electroless). Clutch plates 234 and 240 can be made from materials such as aluminum-bronze to allow for the clutch plates 234 240 to act like a bearing surface and allow slipping as well as to minimize galvanic reaction. Although other materials could be used for the clutch plates 234 and 240 and drum 222, this combination appears to provide good results in a salt spray environment. In this embodiment, the material for the clutch plates 234 and 240 was chosen, then the drum 222 material was chosen to allow for machining and minimal galvanic reaction. Heat treating as described above, provided the needed corrosion resistance. Barrel coupling 214 can be made from 316 stainless steel. Likewise, fasteners 236 and other components of drum assembly 208 can be made from other similar corrosion and/or galvanic resistant material such as stainless steel or Nitronic® material.

As indicated above, extendable runways 16A, 16B travel from guide 28 to guide 28 so as to displace the runways 16A, 16B from positions proximate fixed runways 14A, 14B to the cantilevered position 18. The extendable runways 16A, 16B are driven by stationary drives 24A and 24B separately and jointly for a small distance when transitioning to and from drives 24A and 24B. It is very desirable to accurately know the position of each of the extendable runways 16A, 16B for example with respect to fixed runways 14A, 14B. Although encoders of other forms of rotational sensors can be provided on the drives 24A and 24B and used to ascertain the position of each of the runways 16A, 16B, errors can arise when due to transitioning from position signals being obtained from the position sensors associated with the drives 24A, 24B. In a further inventive aspect, the position of each of the extendable runways 16A, 16B is measured directly and continuously with a position sensor operable over the complete movement of the extendable runways 16A, 16B. In one embodiment as schematically indicated in FIG. 1, a position sensor assembly 260 is provided for each extendable runway 16A and 16B and includes a length of line 262 (wire, rope, etc.) that is coupled to a position sensor 264 such as a rotary encoder or the like operably coupled to a spool for winding and unwinding the line 262. The position sensors 264 and associated spools can be fixed to a stationary point such as the ceiling where ends of the lines are attached to and travel with the extendable runways 16A, 16B. In the alternative, the position sensors and associated spools can travel with the extendable runways 16A, 16B, while the ends of the lines are fixedly attached to the stationary point. Various mechanisms such as springs, motors and the like can be used to maintain tension on the line to ensure accurate measurements by the position sensors 264. The lines 262 can extend within partially enclosed or otherwise protected channels.

Although the subject matter has been described in language specific to structural features and/or methodological acts, it is to be understood that the subject matter defined in the appended claims is not necessarily limited to the specific features or acts described above as has been determined by the courts. Rather, the specific features and acts described above are disclosed as example forms of implementing the claims.

What is claimed is:

1. In combination with a pair of runways in a crane system and a pair of hoist assemblies moveable on the runways and a pair of transfer rails selectively disposable transversely to the runways, the transfer rails including racks for at least a portion of one or both of the hoist assemblies to travel on, a spreader assembly locatable between the hoist assemblies and engaging the runways and/or the hoist assemblies to push the runways or hoist assemblies apart during insertion of the transfer rails between the runways.

2. The combination of claim 1 wherein the spreader assembly comprises a first portion engaging one of the runways and/or the hoist assemblies and a second portion engaging another of the runways and/or the hoist assemblies.

3. The combination of claim 1 wherein at least one of the first and second portions comprises a pivotable link.

4. The combination of claim 3 wherein each of the first and second portions comprises a pivotable link.

5. The combination of claim 3, wherein the pivotable link(s) lock in an over-center position in order to push the runways and/or the hoist assemblies apart.

6. The combination of claim 1 wherein forces applied between the runways and/or hoist assemblies are spaced apart so as to orient the runways and/or hoist assemblies parallel to each other.

7. The combination of the claim 1 wherein the spreader assembly engages the hoist assemblies and travels with the hoist assemblies for movement of at least one of the hoist assemblies on the transfer rails.

8. The combination of claim 7 wherein the spreader assembly engages the hoist assemblies with complementary surfaces so as to pull a hoist assembly.

9. The combination of claim land further comprising a position sensor to provide a signal indicative of a position of each end of each transfer rail.

10. The combination of claim 1 and further comprising a plurality of actuators, each actuator configured to lower and lift an end of a transfer rail, the actuators configured to operate the spreader assembly to push the hoist assemblies and/or the runways apart.

11. In a crane system having a pair of runways, a pair of hoist assemblies moveable on the runways and a pair of transfer rails selectively disposable transversely to the runways, the transfer rails including racks for at least a portion of one or both of the hoist assemblies to travel on, a method of inserting the transfer rails between the hoist assemblies and engaging the runways and/or the hoist assemblies by pushing the runways or hoist assemblies apart.

12. A crane system comprising:
a pair of runways;
a pair of hoist assemblies moveable on the runways;
a second pair of rails orthogonal to the pair of runways;
a pair of transfer rails;
an actuator assembly for lowering the transfer rails so as to align the transfer rails with ends of the second pair of rails;
a locking assembly to lock the transfer rails in position aligned with the end of the second pair of rails.

13. The crane assembly of claim 12 wherein the locking assembly comprises a pin an aperture connection.

14. The crane assembly of claim 12 wherein the locking assembly includes at least one inclined surface that engages another surface.

15. The crane assembly of claim 12 and further comprising a link assembly provided at each end of each transfer rail.

16. The crane assembly of claim 15 wherein each link assembly comprise two connected links.

17. An assembly comprising:
a device having synchronized gears, each gear being rotatable about an axis;
a first rack having elements arranged to mate with the gears;
a second rack having elements arranged to mate with the gears, wherein an end of the first rack is disposed proximate an end of the second rack, and wherein elements proximate the aligned ends are modified from those elements further away from the aligned ends.

18. The assembly of claim 17 wherein the elements comprise teeth.

19. The assembly of claim 17 wherein at least one of the width and/or the height of the elements of each rack is smaller in a direction toward the aligned ends.

20. The assembly of claim 17 wherein the modified elements of each of the racks in total correspond to a number of teeth on each gear.

21. A hoist comprising:
a drum;
a support shaft;
a clutch mechanism operable coupled to the drum and the support shaft to allow relative rotational motion between the drum and the support shaft.

22. The hoist of claim 21 and further comprising an adjustment mechanism to adjust frictional forces of the clutch mechanism.

23. The hoist of claim 21 wherein the clutch mechanism comprises a clutch plate engaging an inner surface of the drum.

24. The hoist of claim 21 wherein the clutch plate includes a conically configured surface for engaging the drum.

25. The hoist of claim 23 wherein the clutch mechanism further comprises a second clutch plate configured to engage the drum.

26. The hoist of claim 24 wherein the clutch mechanism further comprises a second clutch plate configured to engage the drum, the second clutch plate including a conically configured surface at least partially facing the first-mentioned conically configured surface of the first-mentioned clutch plate.

27. The hoist of claim 26 and further comprising and further comprising an adjustment mechanism to adjust frictional forces of the clutch mechanism, the adjustment mechanism coupling the first-mentioned clutch plate to the second clutch plate and configured to pull the clutch plates together.

28. The hoist of claim 21 and further comprising a gear disposed about the support shaft and fixedly coupled to drum to rotate therewith independent of rotation of the support shaft.

29. A drum for a hoist made from stainless steel and heat treated at approximately 1850° F.

30. The drum of claim 29 wherein an outer surface of the drum is nickel plated.

31. A crane system comprising:
a fixed runway;
a rail
an extendable runway moveable on the rail toward and away from the fixed runway, the extendable runway being shorter than the rail;
two spaced apart drives for selectively displacing the extendable runway on the rail, each drive configured for displacing the extendable runway along a different portion of the rail;
an extendable line operably coupled to the extendable runway and the rail or another stationary position, the line extending to a different length for each position of the extendable runway on the rail; and
a position sensor operably coupled to the extendable line to provide a signal indicative of a length of a portion of the line that has been extended.
